(19) United States
(12) Patent Application Publication
(10) Pub. No.: US 2008/0134129 A1
(43) Pub. Date: Jun. 5, 2008

(54) DESIGN RULE CHECKING FOR ALTERNATING PHASE SHIFT LITHOGRAPHY

(76) Inventor: Carl Albert VICKERY, Garland, TX (US)

Correspondence Address: TEXAS INSTRUMENTS INCORPORATED, P O BOX 655474, M/S 3999, DALLAS, TX, 75265, US

(21) Appl. No.: 11/565,195

(22) Filed: Nov. 30, 2006

(51) Int. Cl. G06F 17/50

(52) U.S. Cl. 716/20

(57) ABSTRACT

In accordance with the invention, there is a method of designing a lithography mask. The method can comprise generating a first set of polygons to define a trim photomask, generating a second set of polygons to define a phase photomask, and determining which edges of the first set of polygons in the trim photomask and which edges of the second set of polygons in the phase photomask move during application of optical proximity correction. The method can also comprise predicting a predetermined movement amount for any of the edges of the first set of polygons in the trim photomask and for any of the edges of the second set of polygons in the phase photomask that move during application of optical proximity correction, determining whether any of the edges of the first set of polygons in the trim photomask or any of the edges of the second set of polygons in the phase photomask moved by the predetermined movement amount violate a design rule, and applying a mask correction to those edges of the edges of the first set of polygons in the trim photomask and those edges of the second set of polygons in the phase photomask that violate the design rule.

### DESCRIPTION OF THE INVENTION

1. Field of the Invention

This invention relates generally to the field of integrated circuits and more specifically to a method and system for mask pattern correction.

2. Background of the Invention

Masks such as photomasks are typically used in photolithographic systems to define patterns on objects such as integrated circuits. The shape of the mask, however, may sometimes differ from the pattern defined on the object. For example, optical diffraction may cause a resulting pattern defined on an integrated circuit to differ from the shapes on the mask. Consequently, masks are typically adjusted to account for these deviations.

Some portions of the pattern can be affected by other portions of the pattern during the mask making process. This can cause edges in the pattern to move. Conventional systems attempt to check photomask design rules without a priori knowledge of which edges will be moved, and by how much, during the process of applying optical proximity correction (OPC). Applying a correction without knowing which edges will move results in either overly aggressive or overly conservative corrections.

Moreover, conventional systems attempt to check photomask design rules separately from the process of generating the phase and trim mask data. This leads to increased cycle time caused by the need to fix design rule check errors that are discovered at the end of the tapeout flow.

Accordingly, the present invention solves these and other problems of the prior art to provide a method that uses a priori knowledge of which edges will be moved during the OPC process and by how much in order to faithfully reproduce the pattern and to reduce cycle time.

### SUMMARY OF THE INVENTION

In accordance with the invention, there is a method of designing a lithography mask. The method can comprise generating a first set of polygons to define a trim photomask, generating a second set of polygons to define a phase photomask, and determining which edges of the first set of polygons in the trim photomask and which edges of the second set of polygons in the phase photomask move during application of optical proximity correction. The method can also comprise predicting a predetermined movement amount for any of the edges of the first set of polygons in the trim photomask and for any of the edges of the second set of polygons in the phase photomask that move during application of optical proximity correction, determining whether any of the edges of the first set of polygons in the trim photomask or any of the edges of the second set of polygons in the phase photomask moved by the predetermined movement amount will violate a design rule, and applying a mask correction to those edges of the first set of polygons in the trim photomask and those edges of the second set of polygons in the phase photomask that violate the design rule.

In accordance with another embodiment of the invention, there is a method for correcting a photomask. The method can comprise generating a first set of polygons, wherein the polygons in the first set of polygons comprise edges, so as to define a trim photomask, generating a second set of polygons, wherein the polygons in the second set of polygons comprise edges, so as to define a phase photomask, and projecting which edges of the polygons in the first set of polygons move during application of optical proximity correction and which edges of the polygons in the first set of polygons do not move during application of optical proximity correction. The method can also comprise projecting which edges of the polygons in the second set of polygons move during application of optical proximity correction and which edges of the polygons in the second set of polygons do not move during application of optical proximity correction, segregating edges of the polygons in the first set of polygons that move during application of optical proximity correction from edges of the polygons in the first set of polygons that do not move during application of optical proximity correction, and segregating edges of the polygons in the second set of polygons that move during application of optical proximity correction from edges of the polygons in the second set of polygons that do not move during application of optical proximity correction. Still further, the method can comprise projecting a predetermined movement amount of the edges of the polygons in the first set of polygons that move during application of optical proximity correction, projecting a predetermined movement amount of the edges of the polygons in the second set of polygons that move during application of optical proximity correction, and determining whether the edges of the polygons in the first set of polygons moved the predetermined amount violate a design rule. Moreover, the method can comprise determining whether the edges of the polygons in the second set of polygons moved the predetermined amount violate the design rule, applying a first correction to the edges of the polygons in the first set of polygons that violate the design rule, and applying a second correction to the edges of the polygons in the second set of polygons that violate the design rule.

According to another embodiment of the invention there is a computer readable medium comprising program code that configures a processor to perform a method of correcting a lithography mask. The computer readable medium can comprise program code for generating a first set of polygons to define a trim photomask, program code for generating a second set of polygons to define a phase photomask, program code for determining which edges of the first set of polygons in the trim photomask and which edges of the second set of polygons in the phase photomask move during application of optical proximity correction, and program code for predicting a predetermined movement amount for any of the edges of the first set of polygons in the trim photomask and for any of the edges of the second set of polygons in the phase photomask that move during application of optical proximity correction. The computer readable medium can also comprise program code for determining whether any of the edges of the first set of polygons in the trim photomask or any of the edges of the second set of polygons in the phase photomask moved by the predetermined movement amount violate a design rule and program code for applying a mask correction to those edges of the edges of the first set of polygons in the trim photomask and those edges of the second set of polygons in the phase photomask that violate the design rule.

Additional advantages of the embodiments will be set forth in part in the description which follows, and in part will be obvious from the description, or may be learned by practice of the invention. The advantages will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate embodiments of the invention and together with the description, serve to explain the principles of the invention.

### BRIEF DESCRIPTION OF THE DRAWINGS

FIG. 1 is a diagram illustrating correction of a mask pattern.

FIG. 2 illustrates one embodiment of a system for correcting a mask pattern.

FIG. 3 is a flowchart illustrating one embodiment of a method for correcting a mask pattern.

FIG. 4 is a diagram illustrating correction of a mask pattern that includes multiple polygons.

### DESCRIPTION OF THE EMBODIMENTS

Reference will now be made in detail to the present embodiments, examples of which are illustrated in the accompanying drawings. Wherever possible, the same reference numbers will be used throughout the drawings to refer to the same or like parts.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5.

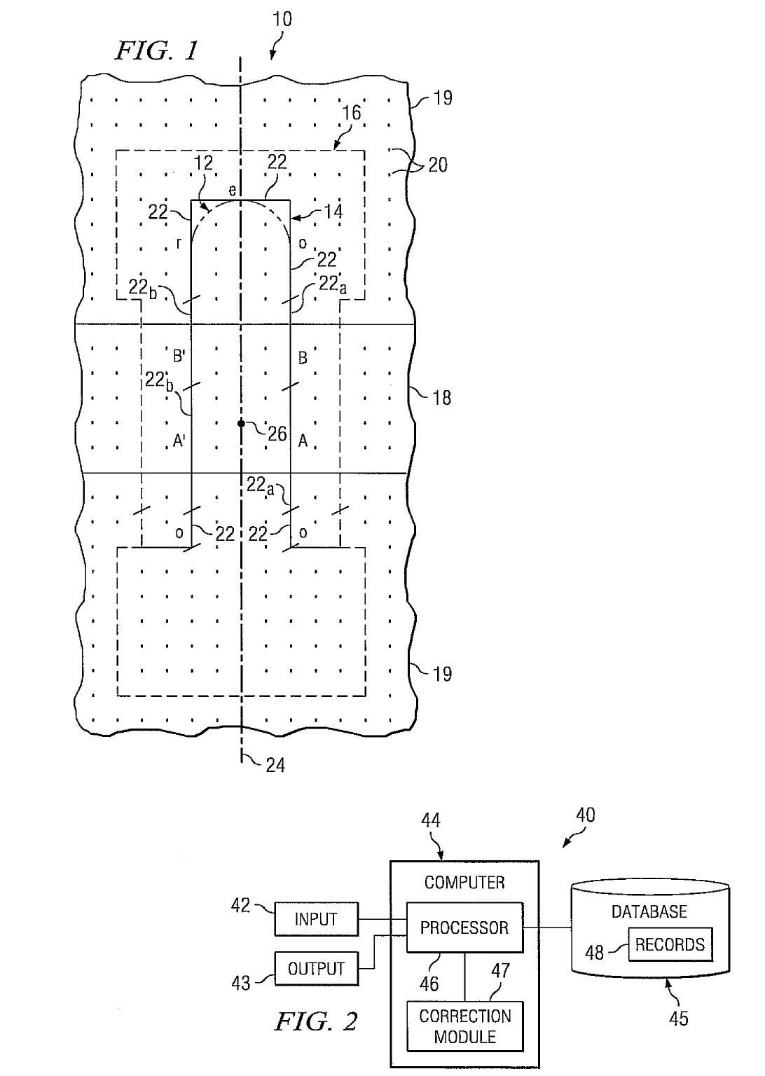

Embodiments of the present invention and its advantages are best understood by referring to FIGS. 1 through 4 of the drawings, like numerals being used for like and corresponding parts of the various drawings.

FIG. 1 is a diagram 10 illustrating correction of a mask pattern. The mask pattern may comprise, for example, all or a portion of any suitable photomask such as a binary mask, an attenuated mask, an alternating phase mask, or any other photomask suitable for defining a pattern on an integrated circuit. Diagram 10 includes a contour 12, an uncorrected pattern 14, and a corrected pattern 16. Uncorrected pattern 14 may be corrected to yield corrected pattern 16 that defines contour 12 on an object.

Contour 12 represents a desired pattern that a mask may define on an object such as an integrated circuit. In the illustrated example, contour 12 defines a transistor gate of an integrated circuit with an active, or diffusion, region 18 and an inactive, or field, region 19. Contour 12 may have critical dimensions. A critical dimension is a dimension that may be required to be defined with a high degree of accuracy. For example, a contour 12 that defines a transistor gate may have the width of the gate as a critical dimension. The width may be required to be defined with an accuracy of, for example, approximately one nanometer.

Uncorrected pattern 14 represents a mask pattern for contour 12 that has not been corrected. Uncorrected pattern 14 may be corrected for deviations that may occur during the manufacturing process of an integrated circuit. For example, deviations may result from optical diffraction, etch effects, mask making errors, resist effects, or other effects occurring during the manufacturing process. To compensate for these deviations, uncorrected pattern 14 may be adjusted to yield corrected pattern 16.

Diagram 10 includes an abstract grid 20 that may define the possible positions of corrected pattern 16. Corrected pattern 16 may be placed on abstract grid 20. Abstract grid 20 may be defined by intervals of, for example, approximately two to five nanometers. The requirement that corrected pattern 16 fall on abstract grid 20 may result in a loss of accuracy, which may affect the formation of contour 12, particularly at the critical dimensions of contour 12.

In the illustrated example, uncorrected pattern 14 may be divided into segments 22 designated as segments A, A′, B, B′, c, d, e, f, and g. A correction for each segment 22 may be computed individually, and each segment 22 may be adjusted individually from uncorrected pattern 14 to corrected pattern 16. “Each” as used in this document means each member of a set or each member of a subset of the set. Corrections may be computed in a sequential manner around uncorrected pattern 14. For example, the following sequence may be used, segments c, A, B, d, e, f, B′, A′, and g.

In the illustrated example, capital letters represent segments 22 that define a critical dimension. The distance between segment A and segment A′ and the distance between segment B and segment B′ define the width of a gate over diffusion region 18, which is a critical dimension. Segments 22 that define a critical dimension may be matched. For example, segments A and A′ may be matched. The matching of the segments may be recorded. For example, the matching of segments A and A′ may be recorded in a record such as a table associated with segment A′.

Segments 22 that define a critical dimension may be corrected by first correcting a base segment 22a according to a proximity correction, and then correcting a relational segment 22b according to a critical dimension correction. A proximity correction is performed to compensate for deviations that may occur during a manufacturing process. A proximity correction may be performed using, for example, optical proximity correction software such as PROTEUS-OPC software by SYNOPSYS Inc. A critical dimension correction is performed to adjust the position of relational segment 22b with respect to base segment 22a. The critical dimension correction of relational segment 22b is calculated with respect to the position of base segment 22a after the proximity correction. For example, base segment A may be corrected according to a proximity correction. Relational segment A′ may then be corrected according to a critical dimension correction, which is calculated using the position of base segment A after the proximity correction. The critical dimension may be recorded in a record associated with segments 22 that define the critical dimension.

A center line 24 may be used to control the correction of segments 22. Center line 24 may be defined substantially along an axis of symmetry of contour 12. During the correction process, some segments 22 may be moved towards one side and other segments may be moved towards another side, resulting in a jagged pattern. For example, segments A and A′ may be moved towards the left, while segments B and B′ may be moved towards the right. To control this movement, a center point 26 between matched segments 22 may be determined, and segments 22 may be corrected such that center point 26 remains approximately at or near center line 24.

FIG. 2 illustrates a system 40 for correcting a mask pattern. System 40 includes an input device 42 and an output device 43 coupled to a computer 44, which is in turn coupled to a database 45. Input device 42 may comprise, for example, a keyboard, a mouse, or any other device suitable for transmitting data to computer 44. Output device 43 may comprise, for example, a display, a printer, or any other device suitable for outputting data received from computer 44.

Computer 44 may comprise a personal computer, workstation, network computer, wireless computer, or one or more microprocessors within these or other devices, or any other suitable processing device. Computer 44 may include a processor 46 and a correction module 47. Processor 46 controls the flow of data between input device 42, output device 43, database 45, and correction module 47. Correction module 47 may receive descriptions of contour 12 and uncorrected pattern 14, and compute corrected pattern 16 that maybe used to define contour 12.

Database 45 may comprise any suitable system for storing data. Database 45 may store records 48 that include data associated with contour 12, uncorrected pattern 14, and corrected pattern 16. A record 48 may be associated with a segment 22a, and may describe a matching segment 22b or critical dimension corresponding to the segment 22a. Record 48 may describe correction bar 32 that represents of the position of segment 22.

In the embodiments described herein, adjustments can be made to a photomask pattern that can include a pattern for a phase shift mask. However, photomask pattern is not limited to a pattern for a phase shift mask, but could be any suitable type of photomask pattern, such as a conventional binary mask pattern that does not employ phase shifts, an attenuating mask pattern or a trim mask pattern.

As is well known in the art, both trim and phase masks are often used in double exposure methods. Critical features are generally imaged using a phase shift mask, and the non-critical and trim features are imaged in a second exposure using a trim mask. In regions where integrated circuit patterns are formed with a phase mask, such as the case of patterning integrated circuit feature, the trim mask may comprise one or more trim wings. Trim wings are patterns on the trim mask that protect the regions patterned by the phase mask from being imaged during the trim mask exposure.

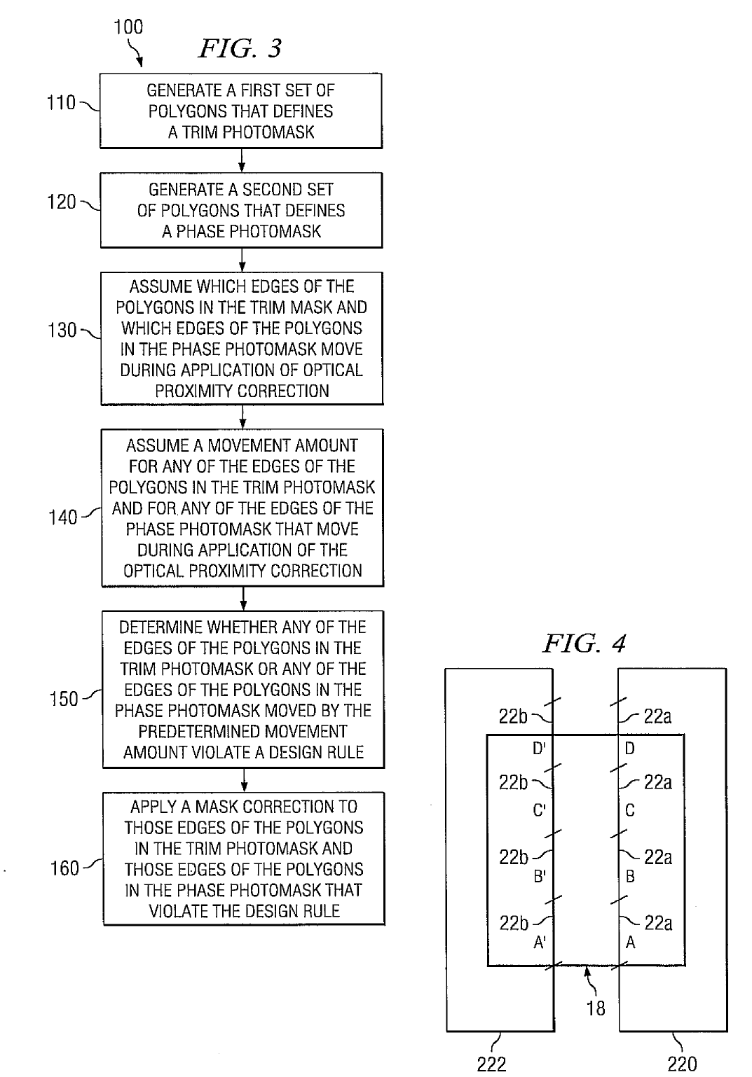

FIG. 3 is a flowchart 100 illustrating one embodiment of a method for correcting a mask pattern. For example, at 110 a first set of polygons is generated to define a trim photomask. As used herein, the term “polygon” refers to various geometric shapes that can be used to form a feature on a substrate. The trim photomask can contain various patterns, such as the drawn polysilicon as well as the trim wings used at each transistor.

Similarly, as shown at 120, a second set of polygons can be generated to define a phase photomask. The phase photomask can include polygons for both the phase 0 and phase π apertures.

At 130, the method can assume which edges of the polygons from the first set and/or the second set will/will not move when manipulated by the OPC process. An example of assuming which polygon edges will/will not move when manipulated by the OPC process can be found in U.S. non-provisional patent application Ser. No. ______ entitled, serial number: UNASSIGNED, Filed: naming as inventors Aton et al, attorney docket number: TI-39046 which is incorporated herein by reference in its entirety. For example, the method can assign a designation to various polygons to indicate their relationship to the trim photomask and phase photomask and whether they move or will not move when applying the OPC process. Designations can be, for example:

trim edges under phase that will not move;

trim edges not under phase that will move;

phase edges abutting trim that will move; and

phase edges not abutting trim that will not move.

Based on the assumption from step 130, the trim edges can be further segregated into two layers, trim edges with OPC and trim edges without OPC. Similarly, the phase edges can be segregated into two layers, phase edges with OPC and phase edges without OPC.

In the method at 140, a predetermined movement amount is predicted for any of the edges of the polygons in the trim photomask and for any of the edges in the phase photomask that move during application of OPC. In various embodiments, a worst-case movement amount can be assumed for the trim layer when processed by OPC. The worst-case outward movement of the trim layer can be assumed and designated max_trim_OPC. Similarly, a worst-case movement amount can be assumed for the phase layer when processed by OPC. The worst-case outward movement of the phase layer can be assumed and designated max_phase_OPC.

The method can then determine whether any of the edges of the polygons in the reference the design rules to determine which photomask design rules must be enforced on the post-OPC data. Moreover, different spacing rules between edges can be checked. For example, spacing rules can checked for various arrangements, such as:

trim without OPC versus trim without OPC;

trim mask spacing;

trim without OPC versus trim with OPC;

trim mask spacing+1*max_trim_OPC;

trim with OPC versus trim with OPC

trim mask spacing+2*max_trim_OPC;

phase without OPC versus phase without OPC

phase mask spacing;

phase without OPC versus phase with OPC

phase mask spacing+1*max_phase_OPC

phase with OPC versus phase with OPC

phase mask spacing+2*max_phase_OPC.

At 150 this rule checking can be embedded in the software used to generate the phase photomask and trim photomask data. At 160 a mask correction can be applied to those edges of the polygons in the trim photomask and those edges in the phase photomask that violate the design rules.

FIG. 4 is a diagram 118 illustrating correction of a mask pattern that includes one or more polygons 120 and 122. The mask pattern may comprise, for example, an alternating phase mask, which may also be referred to as a strong phase shift mask, or any other suitable photomask. A mask pattern may include polygons 120 and 122 that are used to define the width of a transistor gate over diffusion region 18. Polygons 120 and 122 may represent phase blocks. For example, polygon 120 may represent a phase block with a phase shift of approximately zero, and polygon 122 may represent a phase block with a phase shift of approximately π. Polygons 120 and 122 may include base segments 22a, labeled A, B, C, and D, and relational segments 22b labeled A′, B′, C′, and D′. Base segments 22a may be matched with relational segments 22b, for example, segments A and A′ may be matched.

While the examples given have been with respect to patterning transistor gates over diffusion regions, the methods and systems described herein may also be used to correct patterns of other layers of integrated circuits. For example, the interconnect parts of a metal pattern may be divided into base and relational segments for improved critical dimension correction, leaving the corners and contact/via pads to be corrected as traditional placement-correction segments.

While the invention has been illustrated with respect to one or more implementations, alterations and/or modifications can be made to the illustrated examples without departing from the spirit and scope of the appended claims. In addition, while a particular feature of the invention may have been disclosed with respect to only one of several implementations, such feature may be combined with one or more other features of the other implementations as may be desired and advantageous for any given or particular function. Furthermore, to the extent that the terms “including”, “includes”, “having”, “has”, “with”, or variants thereof are used in either the detailed description and the claims, such terms are intended to be inclusive in a manner similar to the term “comprising.”

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method of designing a lithography mask, the method comprising:
generating a first set of polygons to define a trim photomask;
generating a second set of polygons to define a phase photomask;
determining which edges of the first set of polygons in the trim photomask and which edges of the second set of polygons in the phase photomask move during application of optical proximity correction;
predicting a predetermined movement amount for any of the edges of the first set of polygons in the trim photomask and for any of the edges of the second set of polygons in the phase photomask that move during application of optical proximity correction;
determining whether any of the edges of the first set of polygons in the trim photomask or any of the edges of the second set of polygons in the phase photomask moved by the predetermined movement amount violate a design rule; and
applying a mask correction to those edges of the edges of the first set of polygons in the trim photomask and those edges of the second set of polygons in the phase photomask that violate the design rule.

2. The method of designing a lithography mask according to claim 1, wherein the trim photomask comprises drawn polysilicon features and trim wings.

3. The method of designing a lithography mask according to claim 1, wherein the phase photomask comprises polygons for phase-0 and phase-π apertures.

4. The method of designing a lithography mask according to claim 1 further comprising:
determining a comparison for how edges of the first set of polygons in the trim photomask and edges of the second set of polygons in the phase photomask move.

5. The method of designing a lithography mask according to claim 1, wherein the design rules comprise rules that must be enforced on post-optical proximity corrected data.

6. A method for correcting a photomask, the method comprising:
generating a first set of polygons, wherein the polygons in the first set of polygons comprise edges, so as to define a trim photomask;
generating a second set of polygons, wherein the polygons in the second set of polygons comprise edges, so as to define a phase photomask;
projecting which edges of the polygons in the first set of polygons move during application of optical proximity correction and which edges of the polygons in the first set of polygons do not move during application of optical proximity correction;
projecting which edges of the polygons in the second set of polygons move during application of optical proximity correction and which edges of the polygons in the second set of polygons do not move during application of optical proximity correction;
segregating edges of the polygons in the first set of polygons that move during application of optical proximity correction from edges of the polygons in the first set of polygons that do not move during application of optical proximity correction;
segregating edges of the polygons in the second set of polygons that move during application of optical proximity correction from edges of the polygons in the second set of polygons that do not move during application of optical proximity correction;
projecting a predetermined movement amount of the edges of the polygons in the first set of polygons that move during application of optical proximity correction;
projecting a predetermined movement amount of the edges of the polygons in the second set of polygons that move during application of optical proximity correction;
determining whether the edges of the polygons in the first set of polygons moved the predetermined amount violate a design rule;
determining whether the edges of the polygons in the second set of polygons moved the predetermined amount violate the design rule;
applying a first correction to the edges of the polygons in the first set of polygons that violate the design rule; and
applying a second correction to the edges of the polygons in the second set of polygons that violate the design rule.

7. The method of correcting a photomask according to claim 6, wherein the trim photomask comprises drawn polysilicon features and trim wings.

8. The method of correcting a photomask according to claim 6, wherein the phase photomask comprises polygons for phase-0 and phase-π apertures.

9. The method of correcting a photomask according to claim 8, wherein the design rules comprise rules that must be enforced on post-optical proximity corrected data.

10. The method of correcting a photomask according to claim 8, wherein the predetermined movement amount comprises a worst case movement amount.

11. A computer readable medium comprising program code that configures a processor to perform a method of correcting a lithography mask comprising:
program code for generating a first set of polygons to define a trim photomask;
program code for generating a second set of polygons to define a phase photomask;
program code for determining which edges of the first set of polygons in the trim photomask and which edges of the second set of polygons in the phase photomask move during application of optical proximity correction;
program code for predicting a predetermined movement amount for any of the edges of the first set of polygons in the trim photomask and for any of the edges of the second set of polygons in the phase photomask that move during application of optical proximity correction;
program code for determining whether any of the edges of the first set of polygons in the trim photomask or any of the edges of the second set of polygons in the phase photomask moved by the predetermined movement amount violate a design rule;
program code for applying a mask correction to those edges of the edges of the first set of polygons in the trim photomask and those edges of the second set of polygons in the phase photomask that violate the design rule.

12. The computer readable medium according to claim 11, wherein the trim photomask comprises drawn polysilicon features and trim wings.

13. The computer readable medium according to claim 11, wherein the phase photomask comprises polygons for phase-0 and phase-π apertures.

14. The computer readable medium according to claim 11 further comprising:
program code for determining a comparison for how edges of the polygons in the trim photomask and edges of the polygons in the phase photomask move.

15. The computer readable medium according to claim 11, wherein the design rules comprise rules that must be enforced on post-optical proximity corrected data.

16. A semiconductor device made according to the method of claim 1.
